(19) United States
(12) Patent Application Publication
(10) Pub. No.: US 2026/0059447 A1
(43) Pub. Date: Feb. 26, 2026

(54) SATELLITE UPDATES TO IOT DEVICES OVER THE AIR

(71) Applicant: T-Mobile Innovations LLC, Overland Park, KS (US)

(72) Inventors: Anbalagan ELUMALAI, Issaquah, WA (US); Srikanth BIONAPALLY, Sammamish, WA (US); Paul Marvin CHY, Snohomish, WA (US); Anupama MALIREDDY, Sammamish, WA (US)

(21) Appl. No.: 18/814,821

(22) Filed: Aug. 26, 2024

(51) Int. Cl. H04W 52/02; H04W 8/22; H04W 84/06

(52) U.S. Cl. CPC H04W 52/0235; H04W 8/22; H04W 84/06

(57) ABSTRACT

Systems and methods are provided for managing connection to a non-terrestrial network (NTN). The system determines whether wireless devices are within the NTN coverage, and the detected devices are configured to enter a low-energy consumption mode. The system periodically checks for any required updates to the wireless devices, such as firmware/software updates or security patches. If an update is necessary, a message is sent to the wireless devices to switch the device from the low-energy consumption mode to a setup mode. An update is sent to the device via the NTN, and, upon reception of the update, the processor executes the required update on the corresponding wireless device. Once the desired update is made, the device is instructed to reenter the low-energy consumption mode, and the device modification is registered.

### TECHNICAL BACKGROUND

Despite powerful Long Term Evolution (LTE) and Fifth Generation (5G) wireless networks, well over half a million square miles of the U.S. and vast stretches of ocean are untouched by cell signals. Mobile Network Operators (MNO) have struggled to cover these areas with traditional terrestrial cellular technology, most often due to land-use restrictions (e.g., National Parks), terrain limits (e.g., mountains, deserts and other topographical realities) and land size. In those areas, people and devices are disconnected, and in scenarios requiring real-time data transmission, the absence of connectivity could lead to critical delays in decision-making and potentially hazardous outcomes.

Efficient energy management strategies are needed to extend the operational lifespan of the wireless devices under such conditions. There is a need for alternative communication methods, such as satellite communications, which can provide backup connectivity solutions for wireless devices when conventional networks fail.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 depicts a system of non-terrestrial and terrestrial networks, in accordance with disclosed examples.

FIG. 2 depicts a system of non-terrestrial and terrestrial networks, in accordance with disclosed examples.

FIG. 3 depicts an exemplary system for wireless communication in accordance with various aspects of the present disclosure.

FIG. 4 depicts an exemplary network architecture with a service network in accordance with various aspects of the present disclosure.

FIG. 5 depicts a flowchart illustrating an exemplary method for controlling wireless devices via a network connection, in accordance with the disclosed examples.

FIG. 6 depicts a flowchart illustrating an exemplary method for updating a wireless device via a network connection, in accordance with the disclosed examples.

### OVERVIEW

Various aspects of the present disclosure relate to systems, methods and computer readable media for managing connections to a non-terrestrial network (NTN). The system determines whether wireless devices are within the NTN coverage. The wireless devices are configured to enter a low-energy consumption mode. The system periodically checks for any required updates to the wireless devices, such as firmware/software updates or security patches. When the system determines that an update is necessary, an IoT service enabler uses an SMS center to send a message to a wireless device in the area of NTN coverage to switch the device from the low-energy consumption mode to a setup mode.

The change made by the IoT service enabler alerts the device that an update is sent to the device. Next, an over-the-air device provision (OTA DP) system component sends the required update to the wireless device in the setup mode and wireless device executes the required update. Once the desired update to the wireless device is completed, the device is reconfigured to reenter the low-energy consumption mode.

The system uses a satellite trigger data protocol to configure the device to enter the low-energy consumption mode, to switch the device to the setup mode, and to reconfigure the device to reenter the low-energy consumption mode. The system further uses a short message service center (SMSC) to send messages to the wireless device to change the operating modes from low-energy consumption to the setup mode.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the particular systems and methods described herein, the operations described herein may be implemented as computer-readable instructions or methods, and a processor on the network for executing the instructions or methods. The processor may be an electronic processor included in a wireless device.

From the middle of Death Valley to the Great Smoky Mountains or even that persistent neighborhood dead zone, satellite mobile service provides a crucial additional layer of connectivity in areas previously unreachable by cell signals from any provider. The combination of an MNO's terrestrial network (TN) and non-terrestrial network (NTN) allows satellite mobile service to work with a regular mobile device and does not require extra equipment such as a separate satellite mobile device. Even in many of the most remote locations previously unreachable by traditional cell signals, an NTN can provide nearly complete coverage almost anywhere the device has an unobstructed path towards the sky.

An NTN, such as a network of satellites in Earth orbit, combined provide near complete coverage in most places in the U.S.—even in many of the most remote locations previously unreachable by traditional cell signals. The NTN can provide wireless devices with text messaging, SMS, MMS, and data coverage.

TNs such as 5G networks or other generations of wireless networks provide connectivity at a variety of locations to a variety of users with increased capacity and high user data rates. These capabilities facilitate the Internet of Things (IoT), which is aimed at collecting and sending data with different purposes and over different usage scenarios, such as enhanced Mobile Broadband (eMBB), Ultra-Reliable and Low Latency Communications (URLLC), and massive Machine Type Communications (mMTC).

As mentioned, TN may not, in some instances, ensure proper access to Internet and other communication services in remote areas or where the infrastructure is damaged due to natural extreme events, for example. In addition, smart cities cause considerable demand for broadcasting infrastructure with broadband connectivity and reliable emergency communication networks. Such services benefit from the combination of a variety of communication technologies, including NTN platforms. In addition to providing data links in those areas where terrestrial infrastructures are not available, satellites are recognized as an alternative and often better option for certain machine type communications, information dissemination, broadcast, as well as for some delay tolerant services. Moreover, the decreased satellite bandwidth cost since the appearance of the High-Throughput Satellites (HTS) renders satellites as a reliable and cost-effective complement to terrestrial infrastructure for delivering broadband communications.

Turning now to the figures, various devices, systems, and methods in accordance with aspects of the present disclosure will be described.

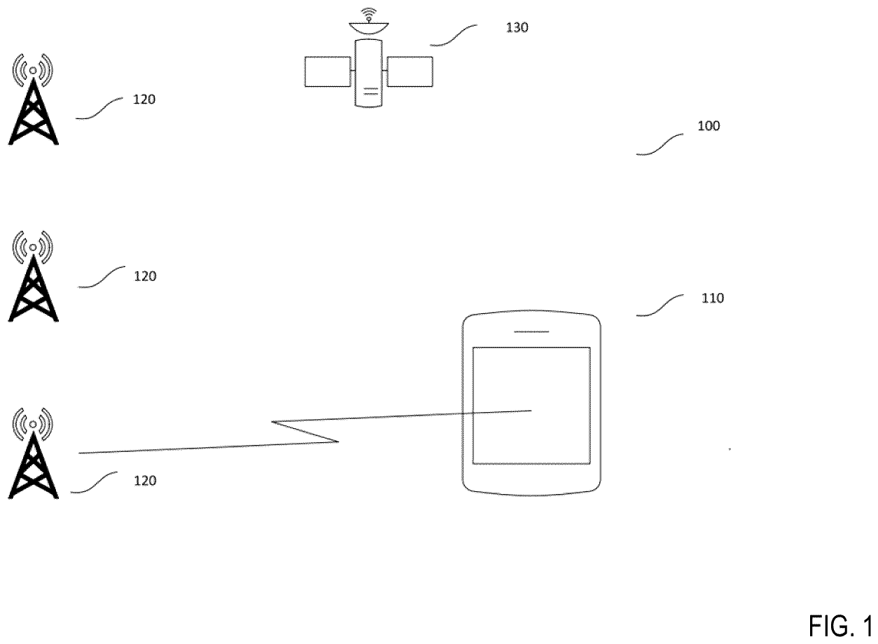

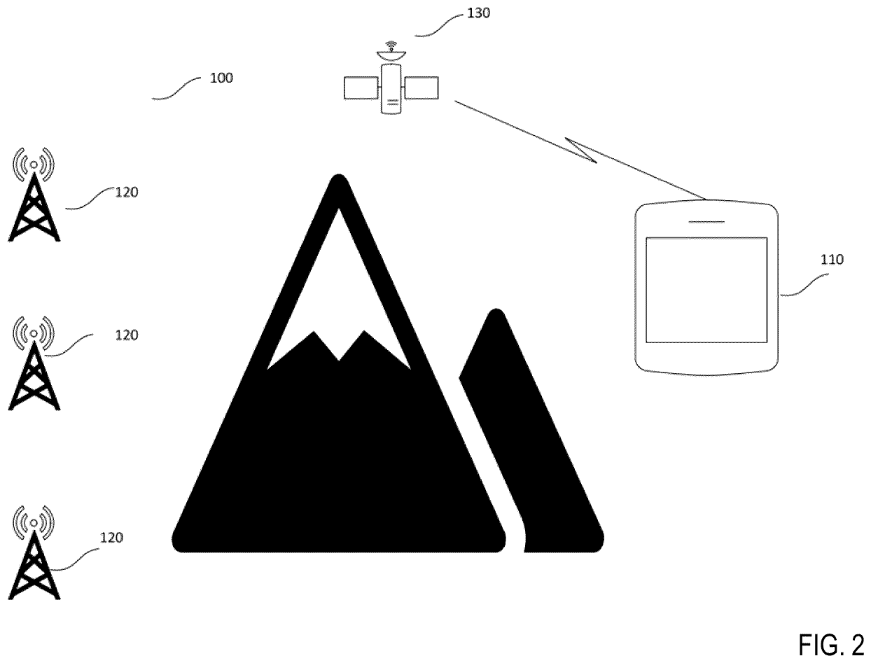

FIGS. 1 and 2 represent system 100 illustrating a combination of a TN and NTN. System 100 includes a wireless device 110. Wireless devices include a smart phone, such as a standard out-of-the-box smart phone provided by an MNO, mobile phone, a wireless phone, a wireless modem, a personal digital assistant (PDA), a voice over internet protocol (VoIP) phone, a voice over packet (VOP) phone, or a soft phone smart watches and other wearables, industrial sensors, and video surveillance equipment, for example. In one embodiment, a wireless device is a smart meter used in utilities (electricity, water, gas) to transmit usage data to service providers. In another embodiment, a wireless device is a connected vehicle equipped with telematics systems that can send and receive data for navigation, diagnostics, and infotainment. In still another embodiment, a wireless device is a smartwatch or a fitness tracker that can send health and activity data over cellular networks. In still another embodiment, a wireless device is an asset tracking device used for logistics and supply chain management to track the location and condition of goods. In further another embodiment, a wireless device is a remote monitoring system used in agriculture, environmental monitoring, and other fields to transmit sensor data to central systems.

Some wireless devices may have fewer capabilities than typical devices, such as smart phones, and may require fewer resources from a wireless network to adequately function. In some examples, wireless devices may be reduced capability (RedCap) devices characterized by having a maximum bandwidth of 100MHz or 20MHz depending on which frequency range they are operating on. The RedCap devices may also be limited to one or two receiving (Rx) branches with either one or two MIMO layers being supported, respectively. In some instances, wireless devices may use Lightweight Machine-to-Machine (LwM2M) open protocol from the Open Mobile Alliance (OMA) that manages Internet of Things (IoT) devices. In some examples, the wireless phones utilize LTE technology supported by a frequency division duplex (FDD) band. In some examples, wireless phones are capable of communicating 1.4MHz carriers using a PCS G-Block (5+5MHz).

As shown in FIG. 1, system 100 includes TN 120 and NTN 130. Wireless device 110 is capable of attaching to both TN 120 and NTN 130. System 100 may be operated by an MNO having access to a TN 120 and NTN 130. While depicted as a single wireless device 110, single TN 120 and NTN 130 for illustration, system 100 may comprise multiple wireless devices 110, TNs 120 and NTNs 130.

TN 120 and/or NTN 130 may be a wireless network, such as a cellular network, and can include a core network and a radio access network (RAN) serving multiple wireless devices in a geographical area covered by a radio frequency transmission provided by the access network. As technology has evolved, different carriers within the cellular network may utilize different types of radio access technologies (RATs). RATs can include, for example, third generation (3G) RATs (e.g., WCDMA, UMTS, CDMA etc.), fourth generation (4G) RATs (e.g., WiMax, Long Term Evolution (LTE), etc.), and fifth generation (5G) RATs (new radio (NR)) and 6G. Further, different types of access nodes may be implemented within the access network for deployment for the various RATs. For example, an evolved NodeB (eNB) may be utilized for 4G RATs and a next generation NodeB (gNB) may be utilized for 5G RATs. Deployment of the evolving RATs in a network provides numerous benefits. For example, newer RATs may provide additional resources to subscribers, faster communications speeds, and other advantages.

As access nodes have evolved, TNs may include a combination of multiple terrestrial access nodes such as 4G LTE eNBs and 5G NR next generation gNBs. alternatively, TNs may be 4G, 5G, or other generations of cellular systems. The evolution of 5G RATs has resulted in significant network architectural developments. For example, the 5G core network offers a serviced based architecture (SBA). The 5G core network is delivered through a set of interconnected network functions (NFs). The NFs can access the services of the other NFs in the core network. This is contrast to the 4G LTE evolved packet core (EPC), which implements a fixed-function, hard-wired architecture.

In attaching to a 4G, 5G, or another generation of TN, each wireless device may transmit information to the access node regarding its identity and capabilities including features it supports, so that the network can utilize the features and capabilities of the device. For example, the device may signal to the network, via a wireless capability information message, multiple information types, such as, for example, which wireless communication bands it supports, which RATs it is capable of using, which carrier aggregation combinations it supports, modulation schemes, multiple-input multiple-output (MIMO) support, and the power class of the Wireless device.

NTN 130 may be a wireless network, such as a cellular network, and includes a core network and a radio access network (RAN) serving multiple wireless devices by a radio frequency transmission provided by utilizing orbiting satellites that may be in communication with access nodes of TN 120. The satellites may include geosynchronous equatorial orbit (GEO) satellites, Medium Earth Orbit (MEO) satellites, and low Earth orbit (LEO) satellites. The NTN 130 includes NTN nodes that are not stationed on the ground.

The 3rd Generation Partnership Project (3GPP) classifies satellites as part of the NTN 130, which is considered as a complement to the TNs 120. As defined by 3GPP, an NTN may be one of three types of satellite-based Next Generation Radio Access Network (NG-RAN) architectures: transparent satellite-based NG-RAN, regenerative satellite-based NG-RAN, and multi-connectivity involving satellite-based NG-RAN. Transparent satellite-based NG-RAN implements frequency conversion and a radio frequency amplifier in both uplink and downlink directions. Several transparent satellites may be connected to the same gNB on the ground through New Radio Uplink Unicast (NR-Uu).

Regenerative satellite-based NG-RAN implements regeneration of the signals received from earth. The satellite payload also provides Inter-station Signaling Links (ISL) between satellites. An ISL may be a radio interface or an optical interface that may be 3GPP or non-3GPP defined. The regenerative satellite-based NG-RAN architecture may be gNB processed payload (has both gNB Centralized Unit (gNB-CU) and gNB Distributed Unit (gNB-DU)) processed payload. Multi-connectivity involving a satellite-based NG-RAN applies to transparent satellites as well as regenerative satellites with gNB or gNB-DU function on board.

Wireless device 110 can attach to the TN 120 RAN and NTN 130 RAN depending on available networks and/or location. Wireless device 110 remains attached to TN 120 when a TN 120 is available and/or the wireless device 110 remains within a geofenced area known to have access to the TN 120. In examples, the wireless device 110 attaches to the TN 120 for the best quality of service when the TN 120 is available.

As shown in FIG. 2, when the TN 120 is unavailable and/or the wireless device 110 is outside of a geofenced area known to have access to the TN 120, the wireless device 110 may attach to the NTN 130. Alternatively, or concurrently, when there is no or limited TN 120 coverage, wireless device 110 attaches to the NTN 130. For example, an NTN 130 attachment is advantageous if a wireless device 110 is in a known dead zone or cannot access the TN 120.

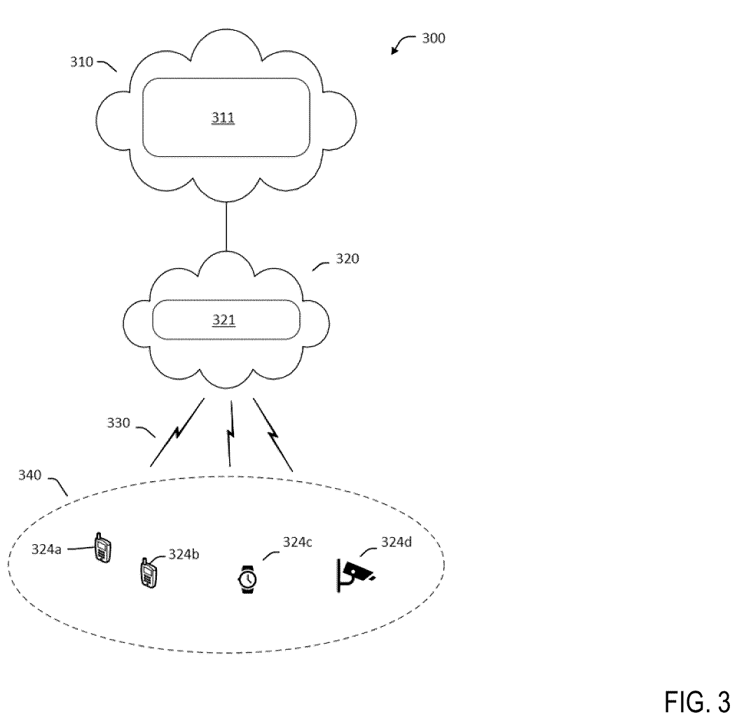

FIG. 3 depicts an exemplary system 300 for wireless communication, in accordance with the disclosed embodiments. The system 300 may include a core network 310, a radio access network (RAN) 320 and multiple wireless devices 324a-d able to communicate within a TN and NTN network. The wireless devices 324a-d may be end-user wireless devices and may operate within one or more coverage areas 340 and communicate with the RAN 320 over communication links 330, which may for example be 5G NR communication links, 4G LTE communication links, or any other suitable type of communication link. The core network 310 includes core network functions and devices 311. The core network may be structured using a service-based architecture (SBA).

The RAN 320 may include various RAN systems and devices 321. The RAN systems and devices 321 are disposed between the core network 310 and the end-user wireless devices 324a-d. Some of the RAN systems and devices 321 may communicate directly with the core network 310 and others may communicate directly with the end user wireless devices 324a-d. Other RAN systems and devices 321 may communicate with one another within the RAN in order to provide services from the core network 310 to the end-user wireless devices 324a-d. In some examples, LTE frequency bands are utilized and are supported by a frequency division duplex (FDD) band. In some examples, wireless phones are capable of communicating 1.4 MHz carriers using a Personal Communication Services (PCS) G-Block (5+5MHz).

The RAN 320 includes at least an access node (or base station), such as an evolved NodeB (eNodeB) or a next generation NodeB (gNodeB) communicating with a plurality of end-user wireless devices. It is understood that the disclosed technology may also be applied to communication between an end-user wireless device and other network resources, such as relay nodes, controller nodes, antennas, etc. Further, multiple access nodes may be utilized. For example, some wireless devices 324a-d may communicate with an LTE eNodeB and others may communicate with an NR gNodeB.

Access nodes can be, for example, standard access nodes such as a macro-cell access node, a base transceiver station, a radio base station, an eNodeB device, an enhanced eNodeB device, a next generation NodeB (or gNodeB) in 5G New Radio (“5G NR”), or other generations of access nodes. In additional embodiments, access nodes may comprise two co-located cells, or antenna/transceiver combinations that are mounted on the same structure. Alternatively, access nodes may comprise a short range, low power, small-cell access node such as a microcell access node, a picocell access node, a femtocell access node, or a home eNodeB device.

Access nodes can be configured to deploy at least two different carriers, each of which utilizes a different RAT. For example, a first carrier may be deployed by an access node in an LTE mode, and a second carrier may be deployed by an access node in an NR mode. Thus, in an embodiment, the access node may comprise two co-located cells, or antenna/transceiver combinations that are mounted on the same structure. In some embodiments, multiple access nodes may be deployed and each access node may support a different RAT. For example, a gNodeB may support NR and an eNodeB may provide LTE coverage. Any other combination of access nodes and carriers deployed therefrom may be evident to those having ordinary skill in the art in light of this disclosure.

The access nodes can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

Each of wireless devices 324a-d may be capable of simultaneously communicating with the RAN 320 using combinations of antennae via 4G and 5G or any other RAT or transmission mode, including multiple carriers. For instance, MU-MIMO pairings and SU-MIMO pairings can be made by wireless devices 324a-d. It is noted that any number of access nodes, antennae, MU-MIMO pools, carriers, and wireless devices can be implemented. Wireless devices 324a-d may include smart watches and other wearables, industrial sensors, and video surveillance equipment, for example. Other types of communication platforms are possible. In examples, wireless devices 324a-d may be considered a RedCap wireless device if its network requirements are lower than typical wireless devices. For example, RedCap wireless devices may be characterized by having a maximum bandwidth of 100MHz or 20MHz depending on which frequency range they are operating on. They may also be limited to one or two Rx branches with either one or two downlink MIMO layers being supported, respectively. They also may have a maximum modulation order of 64QAM rather than the 256 QAM for eMBB devices.

System 300 may further include many components not specifically shown in FIG. 3 including processing nodes, controller nodes, routers, gateways, and physical and/or wireless data links for communicating signals among various network elements. System 300 may include one or more of a local area network, a wide area network, and an internetwork (including the Internet). System 300 may be capable of communicating signals and carrying data, for example, to support voice, push-to-talk, broadcast video, and data communications by end-user wireless devices 324a-d. Wireless network protocols may include one or more of Multimedia Broadcast Multicast Services (MBMS), code division multiple access (CDMA) 1xRTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), Fifth Generation mobile networks or wireless systems (5G, 5G New Radio (“5G NR”), or 5G LTE), and/or other protocols. Wired network protocols utilized by communication network 101 may include one or more of Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or other protocols.

Other network elements may be present in system 300 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. the core network functions and devices 311 and RAN 320.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication system 300 may be, comprise, or include computers systems and/or processing nodes. This includes, but is not limited to core network functions and devices 311, and RAN systems and devices 321.

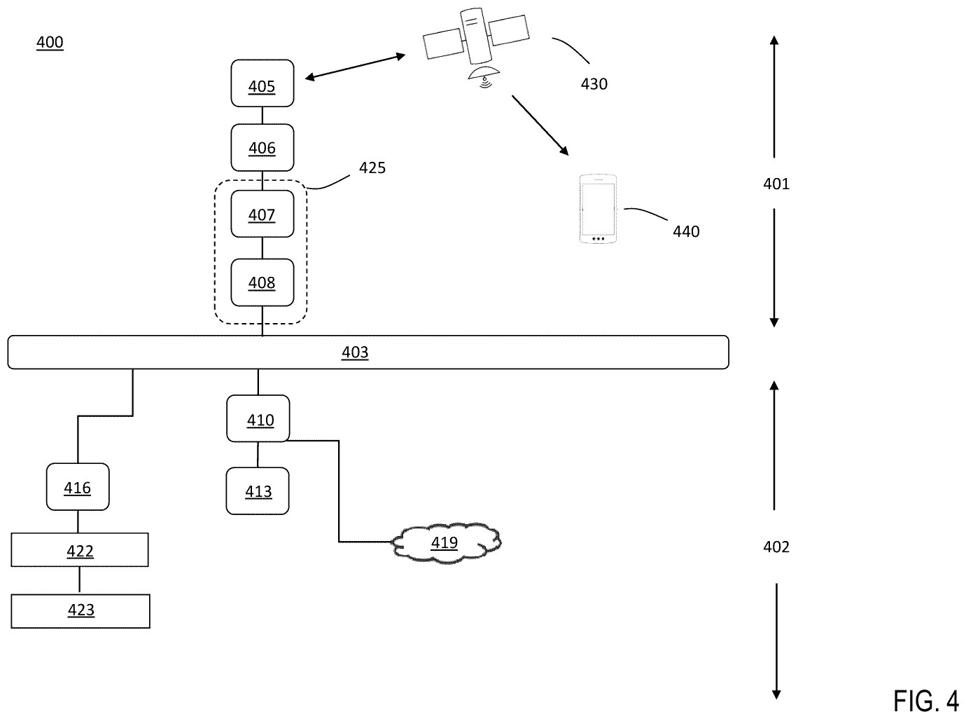

Referring next to FIG. 4, a network architecture system 400 is shown with an IoT service network that includes visited public land mobile network (VPLMN) 401 and home public land mobile network (HPLMN) 402 of a wireless device 440. The VPLMN 401 portion of the network architecture system 400 includes an NTN 430 with a coverage for wireless device 440. In one embodiment, the wireless device 440 executes instructions from the NTN 430 on the timing, size and content of the software updates sent to a wireless device 440 via the VPLMN 401.

The NTN 430 may be provided by a satellite that uses a phased array antenna, which includes multiple individual antenna elements, controlled in terms of phase and amplitude of the signal. By adjusting the phase and amplitude parameters, the antenna can dynamically steer the direction of its beam without physically moving the antenna. The phased array antenna can generate multiple beams simultaneously, enabling the antenna to cover multiple directions at once or to track multiple targets. The antenna can adjust its beam pattern in real-time to optimize signal strength and quality, reducing interference and improving communication performance. The phased array antenna can be scaled by adding more elements, which increases the resolution of beam steering and the overall gain of the antenna.

In one embodiment, the antenna of the NTN 430 satellite includes multiple radiating elements arranged in a specific pattern (linear, planar, or circular arrays). Each element may be equipped with a phase shifter that can alter the phase of the signal it emits. By adjusting the phase of the signals from each element, the waves emitted by the elements can interfere constructively in the desired direction (increasing signal strength) and destructively in other directions (reducing signal strength). By changing the phase settings of the elements, the main beam can be steered in different directions.

Moreover, the NTN 430 may provide a signal to a satellite gateway 405. The gateway 405 may be a ground station, earth station, or teleport that enables communication between the satellite and the ground infrastructure. In one embodiment, the gateway transmit signals to the satellite (uplink) and receive signals from the satellite (downlink), including data, voice, video, and other types of communications. The gateway 405 may perform frequency conversion, translating the signal frequencies used in terrestrial components to those used by satellites and vice versa, such as converting the uplink and downlink frequencies.

The gateway 405 may modulate the data into a format suitable for transmission over the satellite link and demodulate incoming signals from the satellite back into a format suitable for terrestrial networks. In one embodiment, the gateway 405 handles various signal processing tasks, including error correction, data compression, and encryption/decryption to ensure reliable and secure communication. The gateway 405 may monitor the performance of the satellite link and manage the operational aspects of the communication system, including power levels, signal quality, and troubleshooting.

Further, an S1 aggregator 406 interface may be the interface between the base station and the Evolved Packet Core (EPC) 425 that contains a Mobility Management Entity (MME) 407 and a Serving Gateway (SGW) 408. In one embodiment, the aggregator 406 consolidates multiple network connections or data streams into a single connection or stream to enhance efficiency, manageability, and performance in the VPLMN 401. Further, the aggregator 406 may track satellites to route S1 traffic and encapsulate S1 traffic into a NTN 430 tunnel. The aggregator 406 further ensures proper encapsulation and handling of communication protocols (e.g., LTE protocols) over the satellite network and manages differences in latency and throughput between TN and NTN links. The aggregator 406 may optimize the use of available NTN 430 bandwidth by efficiently managing and scheduling aggregated traffic and implement Quality of Service (QoS) policies to ensure high-priority traffic is delivered with minimal delay. Moreover, the aggregators 406 may enhance network resilience by providing failover capabilities and load balancing among multiple NTN links.

The EPC 425 manages data and voice services as wireless device 440 and devices move across the network. The EPC 425 provides packet-switched services for mobile users and devices. The EPC 425 supports mobility management, quality of service (QoS) enforcement, policy control, security, interfacing with external networks such the HPLMN 402, for example.

The MME 407 handles signaling related to mobility and session management. Some of the functions of the MME 407 include mobility management, session management, security, paging and handover control, and bearer management. In certain embodiments, the MME 407 manages the tracking of user devices across different cell sites and base stations, handles user registration, authentication, and location updates, establishes, maintains, and terminates data sessions between the wireless device 440 and the network, and coordinates with the SGW 408 to manage the data flow.

Further, the MME 407 may authenticate users, establish security keys for encryption and integrity protection of user data, manage paging procedures to locate and communicate with idle users, coordinate handovers between the base stations, and manage the establishment, modification, and release of bearers (logical channels) that carry user data.

The SGW 408 is a component of the user plane of the EPC 425 that forwards user data packets between the base stations and the Packet Data Network Gateway (PGW) 410 via an interconnector 403. Some of the functions include data routing and forwarding, mobility anchoring, packet inspection and filtering, QoS enforcement, etc. In one example of the EPC 425, the MME 407 is configured to handle the control plane, managing signaling and control tasks such as user authentication, mobility management, and session setup, while the SGW 408 is configured to handle the user plane, focusing on the transmission and routing of user data packets.

The PGW 410 acts as a bridge between the VPLMN 401 and the Internet 419 via the interconnector 403. The PGW 410 handles IP address allocation, routing and forwarding of data packets, policy enforcement, traffic shaping, and security functions.

An IP Multimedia Subsystem (IMS) core 413 is a component of the system 400 that delivers and manages IP-based multimedia services. The IMS core 413 includes a call session control function (CSCF), a home subscriber server (HSS), a media gateway control function (MGCF), a media resource function (MRF), a breakout gateway control function (BGCF), and an application services (AS), which are components of the IMS core 413 that work together to provide session management, service provisioning, user authentication, QoS control, interoperability, policy enforcement, and security. In one embodiment, the IMS core 413 manages the setup, modification, and teardown of multimedia sessions.

Short Message Service Center (SMSC) 416 manages the storage, routing, and forwarding of Short Message Service (SMS) messages. SMSC 416 supports message interworking between the VPLMN 401 and HPLMN 402, ensuring that SMS messages can be exchanged seamlessly across the interconnector 403.

In one embodiment, the SMSC 416 delivers messages to Over-The-Air Device Provisioning (OTA DP) 422. The OTA DP 422 remotely configures and provisions mobile devices with necessary settings, applications, and updates without requiring physical access to the device. The OTA DP 422 allows MNOs or service providers to remotely configure wireless device 440 settings such as network parameters (APN settings), email configurations, and access to specific services. The OTA DP 422 further facilitates the remote installation and updating of wireless device's 440 firmware, operating system (OS) updates, and application updates, thus ensuring that wireless device 440 is up-to-date with the latest software improvements and security patches.

The OTA DP 422 enables the remote installation and provisioning of applications (e.g., pre-installed apps, service-specific apps) onto Wireless device 440 without requiring users to manually download or install them. New services or features can be activated on mobile devices remotely through OTA DP. This includes activating new network services, multimedia messaging (MMS), and mobile internet services. The OTA DP 422 allows for centralized management of device configurations, ensuring uniformity across a fleet of devices and simplifying administrative tasks for service providers.

The OTA DP 422 further conveys messages to an IoT service enabler 423. In one embodiment, the enabler 423 is a platform that facilitates the creation, deployment, and management of Internet of Things (IoT) services and applications used for wireless device 440. The enabler 423 facilitates the registration and integration of wireless device 440 into the HPLMN 402 and allows remote configuration of device settings, firmware updates, and monitoring of device health. The IoT service enabler 423 provides real-time visibility into device status, connectivity, and performance metrics.

In terms of connectivity, the enabler 423 supports connectivity across the VPLMN 401 and HPLMN 402 and manages the communication protocols between the wireless device 440 and the HPLMN 402. In one embodiment, the enabler 423 implements security measures such as authentication, encryption, and access control to protect IoT data and devices. In another embodiment, the enabler 423 collects data from the wireless device 440, sensors and gateways in real-time or at scheduled intervals and performs data aggregation, transformation, and analysis to derive actionable insights and support decision-making. The enabler 423 may presents data in dashboards and reports for users to monitor and analyze IoT operations.

In one embodiment, the IoT service enabler 423 includes adaptive communication protocols that wakeup the wireless device 440 when needed, such as in emergency situation for software updates, designing energy-efficient strategies to prolong device uptime, and implementing robust data handling mechanisms to ensure data integrity during network disruptions. Specifically, the enabler 423 may include a low-energy protocol that enables the wireless device 440 to enter and exit sleep modes based on signals received via NTN 430. This protocol may be designed to extend battery life of the wireless device 440 by reducing the active time of the wireless device 440 and utilizing NTN 430 signals to wake the wireless device 440 when necessary for updates, data transmission, or critical operations.

The low-energy protocol may include signal-triggered activation, adaptive sleep scheduling, and low-power signal reception. The signal-triggered activation portion of the protocol may instruct a satellite to send a wake-up signal to the wireless device 440 triggered via SMSC 416 from the IoT service enabler 423, which can be scheduled or initiated by predetermined events. The adaptive sleep scheduling portion of the protocol integrates environmental and operational data to optimize sleep and wake cycles, reducing unnecessary power consumption. Further, the low-power signal reception portion of the protocol may employ a low-power module for receiving satellite signals that does not require the processor of the wireless device 440 to be active. In one embodiment, the low-energy protocol is deployed in remote monitoring instances, such as environmental sensors in remote areas or infrastructure monitoring in off-grid locations, where power conservation is paramount.

In another embodiment, a dynamic software updating system for the wireless device 440 device via NTN 430 dynamically adjusts the content and timing of software updates sent to the wireless device 440 via NTN 430 based on the current state of the wireless device 440 and the satellite communication channel conditions. The system may uses predictive analytics to determine optimal update windows and segments updates into smaller, priority-based packages. One of the capabilities of the dynamic software updating system is predictive bandwidth allocation that utilizes machine learning to predict NTN 430 bandwidth availability and the wireless device 440 accessibility, optimizing the timing and size of updates. Updates may be categorized by criticality, with essential security patches prioritized. In one embodiment, only changes since the last update are sent to minimize bandwidth use, with the ability to pause and resume updates based on optimal conditions.

The network architecture system 400 may update the wireless device 440 using the VPLMN 401 and HPLMN 402. In one embodiment, the updates are over-the-air updates performed by the OTA DP 422, which can perform full updates or delta updates. Full updates by the OTA DP 422 may involve replacing the entire software image on the device 440 with a new version. Compared to the delta updates, the full updates require sufficient storage to hold the complete new firmware image alongside the old firmware during the update process. In another embodiment, the OTA DP 422 sends more efficient delta updates, where the OTA DP 422 only transmits the changes between the current firmware version and the new firmware version. The delta update method reduces bandwidth and storage requirements, which may be suitable for devices 440 with limited resources.

In another embodiment, the OTA DP 422 sends firmware over the air (FOTA) updates that are focused on updating the firmware of the Wireless device's 440 hardware components. FOTA updates may be used critical for fixing bugs, patching security vulnerabilities, and improving hardware performance. In yet another embodiment, the OTA DP 422 sends software over the air (SOTA) updates, which entail updating the software components that do not interact directly with the hardware, like application software and user interfaces. SOTA updates can add new features, improve efficiency, and resolve software bugs.

In yet another embodiment, the wireless device 440 receives security patch updates that are released to patch vulnerabilities in software that could be exploited by hackers. Ensuring timely security updates is crucial for maintaining the security integrity of the wireless device 440. In still another embodiment, the wireless device 440 receives incremental updates, which are a form of delta updating where only parts of the software that have changed are sent to the device. The incremental updates are bandwidth-efficient and reduce the time required to update.

In one embodiment, the system 400 uses rolling or continuous updates of the wireless device 440, in instances where the device 440 is designed to receive updates continuously as they become available. This rolling or continuous updates method ensures that wireless device 440 is up-to-date with the latest features and security patches without waiting for manual initiation of updates. In another embodiment, the system 400 issues emergency updates to wireless device 440, when a severe vulnerability or critical bug is identified. The emergency updates are prioritized over regular updates to quickly secure all devices from imminent threats. Each of the above identified update methods requires a reliable network connection and mechanisms to verify the integrity and authenticity of the updates. Managing these updates effectively is of importance to maintaining the operational integrity and security of wireless device 440.

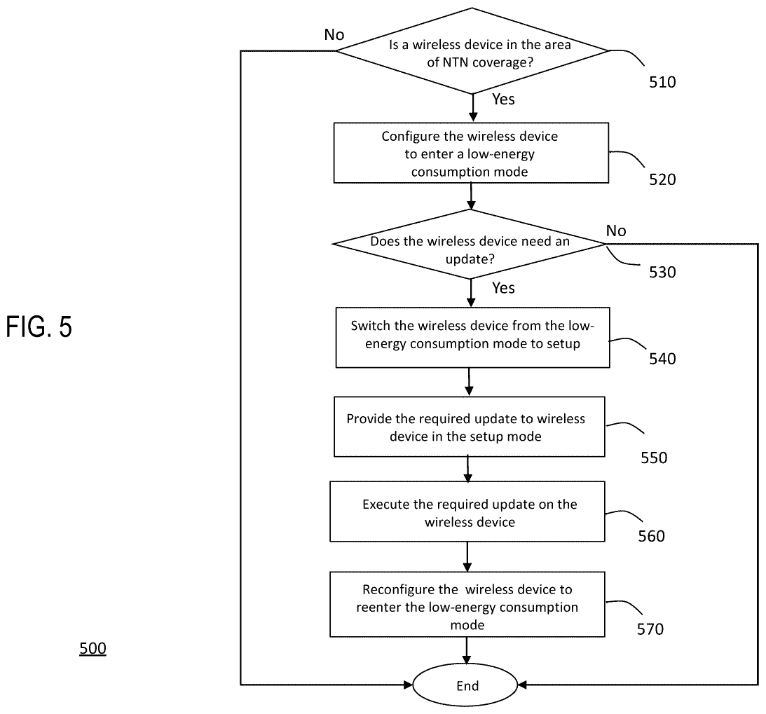

FIG. 5 illustrates an exemplary process flow 500 controlling wireless devices via a network, in accordance with the disclosed examples. The process flow may be implemented for wireless devices that are capable of using a TN and NTN for cellular communication.

The process flow begins at operation 510, when the system 400 determines whether a wireless device 440 is within the VPLMN 401 coverage area. If the wireless device 440 is detected, the NTN 430 provides instructions and updates via NTN 430.

Upon locating a wireless device 440 within the VPLMN 401 coverage area, at operation 520, the system 400 configures the wireless device 440 to enter a low-energy consumption mode. For example, the low-energy consumption mode may enable the wireless device 440 to communicate with a network, such as the system 400, via the low-energy consumption protocol. Such a configuration helps maintain connectivity by preventing the wireless device 440 from wastefully searching for available networks to avoid draining the battery life of the wireless device 440, particularly in areas where network signals are weak. Operation 520 contributes to efficient energy management and extends the operational lifespan of the wireless device 440 under low connectivity conditions.

At operation 530, the system 400 periodically checks whether wireless device 440 requires an update, such as firmware/software update, or a security patch, for example.

Upon determining that an update is necessary, at operation 540, the IoT service enabler 423 contacts the wireless device 440 in the area of NTN 430 coverage to switch the status of the wireless device 440 from the low-energy consumption mode to a setup mode. For example, the setup mode may enable the wireless device 440 to use one or more RATs to communicate with a network, such as the system 400, in order to at least one of send and receive data to configure or update the firmware, software, and/or hardware of the device. The enabler 423 may use a satellite trigger data protocol to perform the switch. The satellite trigger data protocol may use the SMSC 416 to send a message to the wireless device 440 to make the switch and wake up the wireless device 440.

At operation 550, the NTN 430 provides the required update to the wireless device 440 in the setup mode, for example, via OTA DP 422. The update may be an over-the-air (OTA) update, firmware over-the-air (FOTA) update, software over-the-air (SOTA) update, security patch update, incremental update, continuous update, emergency update, etc. The incremental update may be a portion of the update provided to the device 440, and the continuous updates may arrive uninterrupted as the updates become available to the NTN 430.

In one embodiment, a machine learning (ML) model predicts availability of the NTN 430 and accessibility of the wireless device 440 in the setup mode to optimize time and/or size of updates provided to the wireless device 440. In another embodiment, the wireless device 440 provides information to the NTN satellite to control the device 440 and to send the required update to the wireless device 440 via the satellite.

At operation 560, the processor of the device 440 executes the received update, thereby making modifications to the firmware/software of the wireless device 440 to reach the desired operational or security level. Lastly, at operation 570, the IoT service enabler 423 may use a satellite trigger protocol to send a message to wireless device 440 to switch and reconfigure the wireless device 440 to reenter the low-energy consumption mode thus preventing wasteful communication attempts with the NTN 430 until the next instance of a necessary update. In one embodiment, the changes made to the device 440 are communicated to the NTN 430 and then routed to the IoT service enabler 423 by the NTN 430 to register the changes with the IoT service enabler 423.

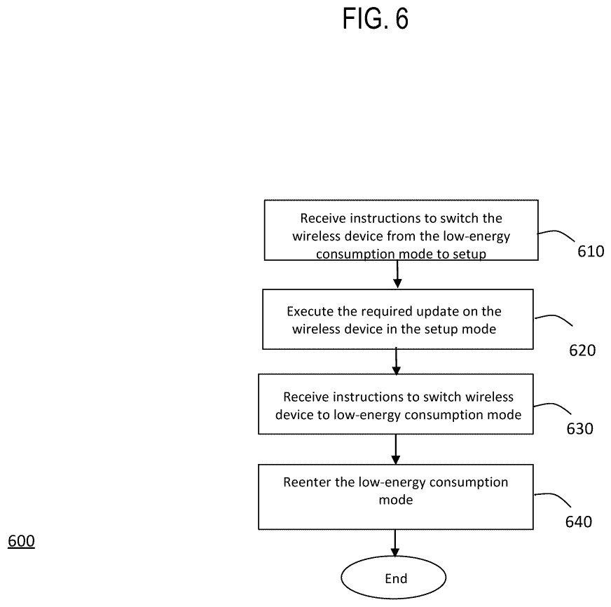

FIG. 6 illustrates an exemplary process flow 600 for updating wireless devices via a network, in accordance with the disclosed examples. The process flow may be implemented for wireless devices that are capable of using a TN and NTN for cellular communication.

The process flow begins at operation 610, in which the wireless device 440 receives instructions via the NTN 430 to switch the status of the wireless device 440 from the low-energy consumption mode to a setup mode. Satellite trigger data protocol may be utilized to perform the switch. The satellite trigger data protocol may use the SMSC 416 to send a message to the wireless device 440 to make the switch and wake up the wireless device 440.

At operation 620, wireless device 440 receives the update from NTN 430 while in the setup mode. The update may be an over-the-air (OTA) update, firmware over-the-air (FOTA) update, software over-the-air (SOTA) update, security patch update, incremental update, continuous update, emergency update, etc. The incremental update may be a portion of the update provided to the wireless device 440, and the continuous updates may arrive uninterrupted as the updates become available to the NTN 430.

At operation 630, the processor of the wireless device 440 executes the received update, thereby making modifications to the firmware/software of the wireless device 440 to reach the desired operational or security level. Lastly, at operation 640, upon completion of the update, the wireless device 440 notifies the NTN 430 that the update is complete and the IoT service enabler 423 may use a satellite trigger protocol to send a message to wireless device 440 to switch and reconfigure wireless device 440 to reenter the low-energy consumption mode back again, thus preventing wasteful communication attempts with the NTN 430 until the next instance of a necessary update. At operation 640, the wireless device 440 reenters low-energy consumption mode.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention and are intended to be illustrative and not restrictive. Many examples and applications other than the examples provided would be apparent to those skilled in the art upon reading the above description. The scope should be determined, not with reference to the above description, but instead with reference to the appended claims, along with the full scope of equivalents to which such claims are entitled. It is anticipated and intended that future developments will occur in the technologies discussed herein, and that the disclosed systems and methods will be incorporated into future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A method comprising:
determining that a wireless device requires an update;
contacting, using a non-terrestrial network (NTN), the wireless device to switch from a low-energy consumption mode to a setup mode; and
providing an update to the wireless device in the setup mode.

2. The method of claim 1, wherein the wireless device is a reduced capability device.

3. The method of claim 2, wherein the method further comprises instructing, via the NTN, the wireless device to reenter the low-energy consumption mode.

4. The method of claim 1, wherein the method further comprises, using a satellite trigger data protocol to:
instruct the wireless device to enter the low-energy consumption mode;
switch the wireless device from the low-energy consumption mode to the setup mode; and
instruct the wireless device to reenter the low-energy consumption mode.

5. The method of claim 4, wherein the satellite trigger data protocol comprises using a short message service center (SMSC) to send a message to the wireless device to switch the wireless device from the low-energy consumption mode to the setup mode.

6. The method of claim 1, wherein the NTN is configured to provide the required update to the wireless device in the setup mode, and not in the low-energy consumption mode.

7. The method of claim 6, wherein a machine learning (ML) model predicts availability of the NTN and accessibility of the wireless devices in the setup mode to optimize time and/or size of updates provided to the wireless device.

8. The method of claim 1, wherein the update is at least one of: over-the-air (OTA) update, firmware over-the-air (FOTA) update, software over-the-air (SOTA) update, security patch update, incremental update, continuous update, and emergency update.

9. The method of claim 8, wherein the incremental update is a portion of the update provided to the wireless devices.

10. The method of claim 3, wherein the method further comprises registering that the wireless device has been successfully updated.

11. A non-transitory computer-readable medium storing instructions that when executed by a processor cause the processor to perform operations comprising:
determining that wireless devices individually require an update;
contacting, using a non-terrestrial network (NTN), the wireless devices to switch from a low-energy consumption mode to a setup mode; and
providing an update individually to the wireless devices in the setup mode.

12. The non-transitory computer-readable medium of claim 11, wherein the wireless devices are reduced capability devices.

13. The non-transitory computer-readable medium of claim 11 further comprising instructing, via the NTN, the wireless devices to reenter the low-energy consumption mode.

14. The non-transitory computer-readable medium of claim 13, wherein a machine learning (ML) model predicts availability of the NTN and accessibility of the wireless devices in the setup mode to optimize time and/or size of updates provided to the wireless devices.

15. The non-transitory computer-readable medium of claim 11, wherein the update is at least one of: over-the-air (OTA) update, firmware over-the-air (FOTA) update, software over-the-air (SOTA) update, security patch update, incremental update, continuous update, and emergency update.

16. A method comprising:
receiving instructions from a non-terrestrial network (NTN) to switch from low-energy consumption mode to setup mode;
executing an update from the NTN in setup mode;
upon completion of the update in setup mode, receiving instructions from NTN to switch from setup mode to low-energy consumption mode; and
reentering low-energy consumption mode.

17. The method of claim 16, wherein the wireless devices are Internet of Things (IoT) devices.

18. The method of claim 16, wherein the instructions from the NTN are short message service (SMS) messages.

19. The method of claim 16, wherein the update is at least one of: over-the-air (OTA) update, firmware over-the-air (FOTA) update, software over-the-air (SOTA) update, security patch update, incremental update, continuous update, and emergency update.

20. The method of claim 16, wherein the instructions are communicated by the NTN to a wireless device utilizing a long-term evolution (LTE) frequency band.
